(19) United States
(12) Patent Application Publication
(10) Pub. No.: US 2017/0208289 A1
(43) Pub. Date: Jul. 20, 2017

(54) METHOD AND SYSTEM FOR AN EYEWEAR MEDIA DEVICE

(71) Applicants: Jedediah Michael Feller, Las Vegas, NV (US); Logan James Hutchison, Las Vegas, NV (US)

(72) Inventors: Jedediah Michael Feller, Las Vegas, NV (US); Logan James Hutchison, Las Vegas, NV (US)

(21) Appl. No.: 15/408,099

(22) Filed: Jan. 17, 2017

Related U.S. Application Data
(60) Provisional application No. 62/279,206, filed on Jan. 15, 2016.

(51) Int. Cl. H04N 5/655; H04N 5/64; G02B 27/01; H04R 1/10

(52) U.S. Cl. CPC H04N 5/655; H04R 1/105; H04N 5/642; G02B 27/0172; H04R 2499/11; H04R 2460/13; G02B 2027/0178; G02B 2027/014

(57) ABSTRACT

A personal media device includes a source of at least one of audio content and visual content, a respective audio phone and visual display device communicatively coupled to the source of at least one of audio content and visual content, the visual display device coupled to eyewear of a user, the visual content visible at least one of directly on the visual display device and indirectly projected onto a lens of the eyewear, and an eyewear interface device including at least one receptacle configured to receive a temple arm of eyewear; a branch configured to support the visual display device in a substantially constant relative position with respect to the eyewear, the branch further configured to support the audio phone proximate an audio receiving portion of a body of the user.

### BACKGROUND

The field of the disclosure relates generally to personal media devices and, more particularly, to a method and system for an eyewear retaining device and personal media device combination.

At least some known personal media or audio/visual (AV) devices are stand alone devices that incorporate one or several forms of following securing methods: contours of the outer ear for retention in the form of earbuds that use mechanical retention by shaping the earbud to fit in the contours of the outer ear, the top of the ear with a retention arm that rests on the superior part of the ear where the ear and skull meet, head strap or bar extending above or behind the head using features of the shape of the skull and/or ears for retention, neck strap or bar surrounding the neck with earbuds extending to the ears, or clipping feature for attaching to clothing with earbuds or over the ear devices. All of these retention features have weaknesses and are frustrating in their application for various reasons.

### BRIEF DESCRIPTION

In one aspect, a personal media device includes a source of at least one of audio content and visual content, a respective audio phone and visual display device communicatively coupled to the source of at least one of audio content and visual content, the visual display device coupled to an eyewear assembly of a user, the visual content visible at least one of directly on the visual display device and indirectly projected onto a lens of the eyewear, and an eyewear interface device. The eyewear interface device includes at least one receptacle configured to receive a temple arm of the eyewear assembly and a branch configured to support the visual display device in a substantially constant relative position with respect to the eyewear, the branch further configured to support the audio phone proximate an audio receiving portion of a body of the user.

In another aspect, a personal media device includes a source of at least one of audio content and visual content. The personal media device also includes a bone conduction transducer and a visual display device communicatively coupled to the source of at least one of audio content and visual content. The visual display device is coupled to an eyewear assembly of a user wherein the visual content is visible at least one of directly on the visual display device and indirectly projected onto a lens of the eyewear assembly. The personal media device includes an eyewear interface device that includes at least one receptacle configured to receive a temple arm of the eyewear assembly; a branch configured to support the visual display device in a substantially constant relative position with respect to the eyewear assembly, the branch further configured to support the bone conduction transducer proximate an audio receiving portion of a body of the user.

In yet another aspect, a method of sensing media content includes coupling a source of at least one of audio content and visual content to an eyewear assembly, supporting the source of at least one of audio content and visual content about the body of a user using the eyewear assembly, transmitting audio content to an inner ear of a user. The source of at least one of audio content and visual content may be supported about the body of the user using the eyewear assembly using a strap assembly coupled to the eyewear assembly. The audio content may be transmitted to an inner ear of a user through at least one of an auditory canal of the user and a cranial bone of the user.

### DRAWINGS

These and other features, aspects, and advantages of the present disclosure will become better understood when the following detailed description is read with reference to the accompanying drawings in which like characters represent like parts throughout the drawings, wherein:

FIG. 1 is a perspective view of a personal media assembly in accordance with an embodiment of the present invention.

FIG. 2 is a perspective view of a personal media assembly in accordance with another embodiment of the present invention.

FIG. 3 is a perspective view of a personal media assembly in accordance with yet another embodiment of the present invention.

FIG. 4 is a side view of the temple arm illustrating a placement of the audio phones embodied as bone conduction earphones and configured to transmit at least a portion of the audio content through at least a portion of the body of the user.

FIG. 5 is a cutaway view of a portion of a human head illustrating sound propagation paths for the audio phones embodied as earbuds and for the audio phones embodied as bone conduction earphones.

Unless otherwise indicated, the drawings provided herein are meant to illustrate features of embodiments of this disclosure. These features are believed to be applicable in a wide variety of systems including one or more embodiments of this disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms “a,” “an,” and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise.

Embodiments of the personal media assembly described herein provide a cost-effective method for providing audio and/or visual information and entertainment more simply and more securely retained by combining an eyewear retaining device with the personal audio device and visual device into a stylish strap, head band or other design. In other embodiments, the eyewear retaining device and an audio visual device are assembled with the personal audio video device fully integrated in the eyewear retaining device. Another embodiment provides for the eyewear retaining/audio visual device to function on its own without the use of eyewear.

A clear understanding of the key features of the invention may be had by reference to the appended drawings, which illustrate the method and system of the invention, although it will be understood that such drawings depict preferred embodiments of the invention and, therefore, are not to be considered as limiting its scope with regard to other embodiments which the invention is capable of contemplating

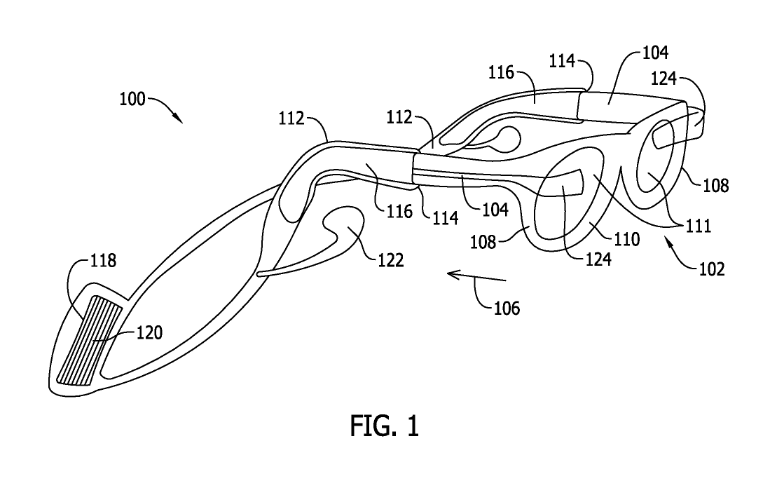

FIG. 1 is a perspective view of a personal media assembly 100 in accordance with an embodiment of the present invention. In the exemplary embodiment, personal media assembly 100 attaches to eyewear 102. Eyewear 102 includes a pair of temple arms 104 extending in an afterward direction 106 from opposing sides 108 of an eyewear frame 110 that contains at least one lens 111. Personal media assembly 100 includes corresponding straps 112 that each includes a receptacle 114 configured to receive an earpiece 116 of temple arms 104 of eyewear 102. In one embodiment, receptacles 114 slidily engage earpieces 116 in a friction or interference fit. In some embodiments, the engagement of receptacles 114 and earpieces 116 is facilitated using an adhesive.

Straps 112 extend behind a neck (not shown) of the user where straps 112 couple to a pocket 118 configured to receive a media device 120. In various embodiments, media device 120 is embodied in, for example, an MP3 player, a Bluetooth® or other near field communication (NFC) device. Media device 120 includes at least audio phones 122 configured to provide audio content to the user while eyewear 102 is positioned on the user's face or while eyewear 102 is hanging about the user's neck supported by straps 112. In various embodiments, audio phones 122 are embodied in earbuds configured to be worn inside the ear of the user, earphones configured to at least partially cover the outer ear of the user, and bone conduction earphones configured to transmit at least a portion of audio content through at least a portion of the body of the user. In some embodiments, media device 120 includes one or more visual display devices 124. One or more visual display devices 124 may be embodied in direct visual devices configured to provide visual content directly to at least one eye of the user. One or more visual display devices 124 may be also embodied in a heads-up display where visual content is projected onto a lens 111 as, for example, as a transparent display that presents data without requiring the user to look away from their usual viewpoints.

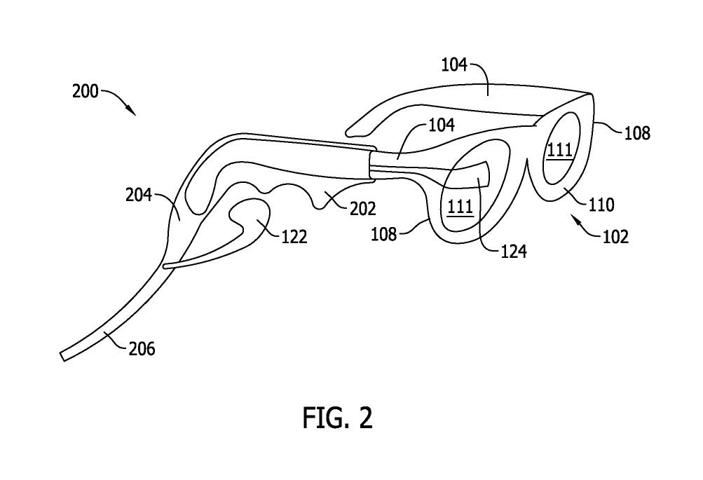

FIG. 2 is a perspective view of a personal media assembly 200 in accordance with another embodiment of the present invention. In the exemplary embodiment, personal media assembly 200 includes a receptacle 202, a branch portion 204, and a conduit portion 206. In some embodiments, receptacle 202 is formed of a moldable resilient material that is contoured to the morphology of the user's anatomy that will receive and support receptacle 202, for example, a superior part of the ear where the ear and skull meet. Such a position for receptacle 202 that is custom moldable to fit the body of the user, permits providing a stable position for audio phones 122. Audio phones 122 are maintained in a consistent position with respect to the users' ears even after repositioning eyewear 102 from the user's face and back again without readjustment.

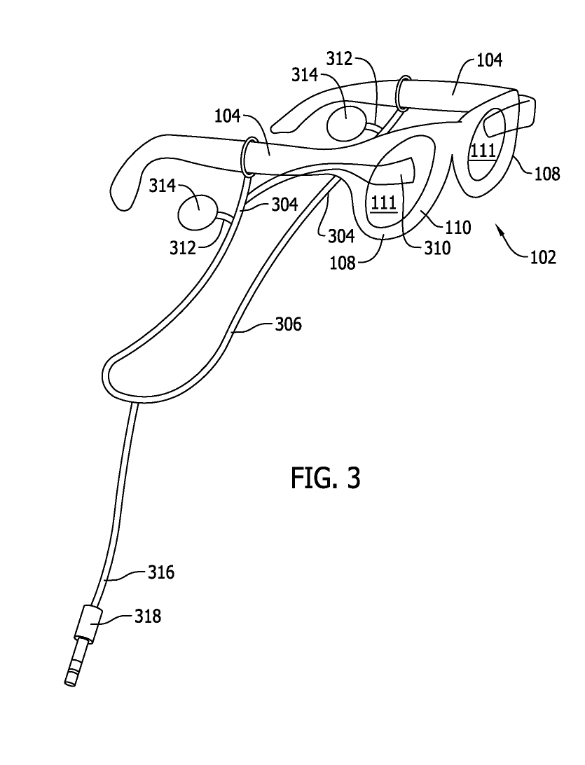

FIG. 3 is a perspective view of a personal media assembly 300 in accordance with yet another embodiment of the present invention. In the exemplary embodiment, personal media assembly 300 includes a hoop 302 configured to receive a respective temple arm 104. Each leg 304 of a strap 306 includes a branch 308 for a visual display device 310 and a branch 312 for an audio phone 314. A distal end 316 of strap 306 includes a connector 318 configured to connect personal media assembly 300 to a source of audio and/or visual content.

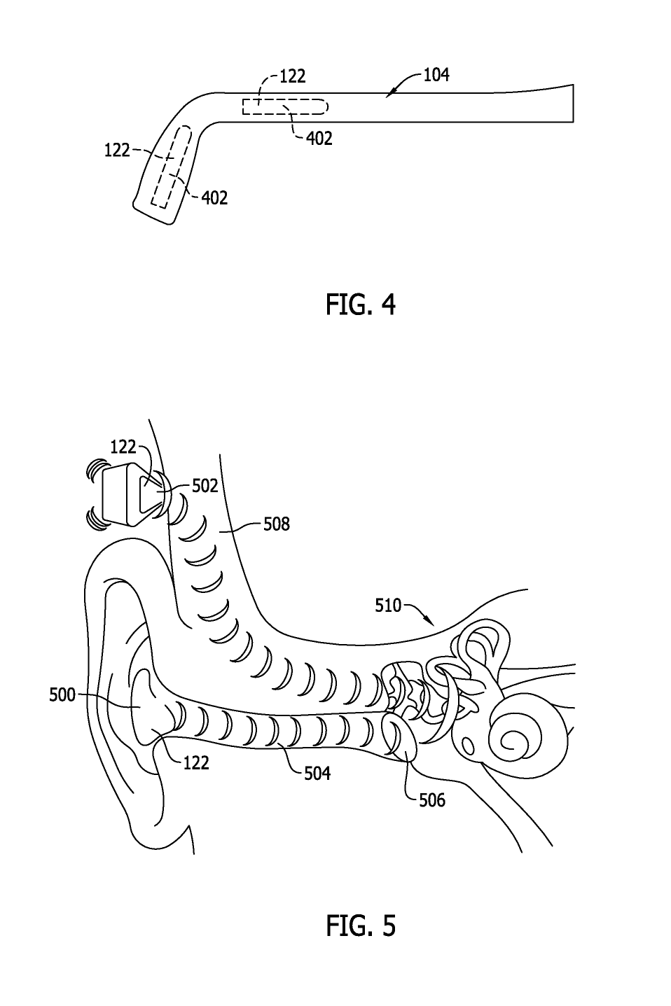

FIG. 4 is a side view of temple arm 104 illustrating a placement of audio phones 122 embodied as bone conduction earphones configured to transmit at least a portion of the audio content through at least a portion of the body of the user. In one embodiment, audio phones 122 are placed on an earpiece of temple arm 104 to enable transmission of audio content through a temporal bone of the user. Sound vibrations are transmitted directly to the temporal bone via audio phones 122 situated behind the ear. In this way, the vibration of the bone surrounding the inner ear is transmitted to the cochlea and the hair cells. Temple arms 104 contain an amplifier and a vibrator portion 402 of audio phones 122, which is applied to the bone behind the ear, such as the temporal bine. The efficiency of bone conduction earphones is influenced by the thickness of the skin, the pressure provided, the contact with the skull and any complications that arise from skin irritation.

FIG. 5 is a cutaway view of a portion of a human head illustrating sound propagation paths for audio phones 122 embodied as earbuds 500 and audio phones 122 embodied as bone conduction earphones 502. In the example embodiment, earbuds 500 are configured to direct sound waves through air in the auditory canal 504 to eardrum 506. In another embodiment, bone conduction earphones 502 are configured to conduct audio vibrations through, for example, a temporal bone 508 of the user to parts of the inner ear.

The above-described personal media assemblies provide an efficient method for providing convenient, comfortable audio and/or visual entertainment with a minimum amount of adjustment as the user maintains their normal activities. Specifically, the above-described personal media assemblies work with existing eyewear options to stabilize the personal media assembly during activity. Additionally, the personal media assemblies provide long-term comfort by relieving the personal media assemblies of a support requirement for the weight of the audio phones and visual display devices.

In various embodiments, the personal media device includes a source of at least one of audio content and visual content and a respective audio phone and visual display device communicatively coupled to the source of at least one of audio content and visual content, the visual display device coupled to an eyewear assembly of a user, the visual content visible at least one of directly on the visual display device and indirectly projected onto a lens of the eyewear. The personal media device also includes an eyewear interface device that includes at least one receptacle configured to receive a temple arm of the eyewear assembly and a branch configured to support the visual display device in a substantially constant relative position with respect to the eyewear, the branch further configured to support the audio phone proximate an audio receiving portion of a body of the user.

The personal media device may also include a right side receptacle and a left side receptacle wherein the right side receptacle is configured to couple to the left side receptacle in an absence of the eyewear assembly. In some embodiments, the source of at least one of audio content and visual content includes a source of at least one of streaming audio content and streaming visual content. The source of at least one of audio content and visual content may also include a media processor coupled to a memory device and/or a communications processor coupled to at least one of the media processor and the memory device. When present, the communications processor is configured to receive media content from a source off board the personal media device.

The audio phone may include a bone conduction transducer configured to couple to the eyewear assembly at for example, to the temple arm of the eyewear assembly and transmit at least a portion of audio content through at least a portion of the body of the user. In various embodiments, the eyewear interface device includes straps that extend behind a neck of the user, and which include a pocket configured to receive a media device.

In various embodiments, the branch is configured to support the audio phone proximate an audio receiving portion of a body of the user when the user is wearing the eyewear assembly and when the eyewear assembly is hanging about the user's neck supported by at least one of straps that extend behind a neck of the user and the branch.

In another embodiment, a personal media device includes a source of at least one of audio content and visual content. The personal media device also includes a bone conduction transducer and a visual display device communicatively coupled to the source of at least one of audio content and visual content. The visual display device may be coupled to an eyewear assembly of a user such that the visual content is visible at least one of directly on the visual display device and indirectly projected onto a lens of the eyewear assembly. The personal media device may also include an eyewear interface device that includes at least one receptacle configured to receive a temple arm of the eyewear assembly and a branch configured to support the visual display device in a substantially constant relative position with respect to the eyewear assembly. The branch is further configured to support the bone conduction transducer proximate an audio receiving portion of a body of the user.

In various embodiments, the audio receiving portion of a body of the user includes a cranial bone of the user, such as, a temporal bone. In at least one embodiment, the bone conduction transducer is coupled to the temple arm. In other embodiments, the bone conduction transducer is affixed to an outer surface of the eyewear interface device. The bone conduction transducer may communicate with the source of at least one of audio content and visual content wirelessly.

In various embodiments, a method of sensing media content includes coupling a source of at least one of audio content and visual content to an eyewear assembly, supporting the source of at least one of audio content and visual content about the body of a user using the eyewear assembly, transmitting audio content to an inner ear of a user. The source of at least one of audio content and visual content may be supported about the body of the user using the eyewear assembly using a strap assembly coupled to the eyewear assembly. The audio content may be transmitted to an inner ear of a user through at least one of an auditory canal of the user and a cranial bone of the user.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A personal media device comprising:
a source of at least one of audio content and visual content;
a respective audio phone and visual display device communicatively coupled to said source of at least one of audio content and visual content, said visual display device coupled to an eyewear assembly of a user, the visual content visible at least one of directly on said visual display device and indirectly projected onto a lens of the eyewear; and
an eyewear interface device comprising:
at least one receptacle configured to receive a temple arm of the eyewear assembly; and
a branch configured to support said visual display device in a substantially constant relative position with respect to the eyewear, said branch further configured to support said audio phone proximate an audio receiving portion of a body of the user.

2. The personal media device of claim 1, wherein said at least one receptacle comprises a right side receptacle and a left side receptacle wherein said right side receptacle is configured to couple to said left side receptacle in an absence of the eyewear assembly.

3. The personal media device of claim 1, wherein said source of at least one of audio content and visual content comprises a source of at least one of streaming audio content and streaming visual content.

4. The personal media device of claim 1, wherein said source of at least one of audio content and visual content comprises a media processor coupled to a memory device.

5. The personal media device of claim 1, wherein said source of at least one of audio content and visual content comprises a communications processor coupled to at least one of said media processor and said memory device.

6. The personal media device of claim 5, wherein said communications processor is configured to receive media content from a source off board said personal media device.

7. The personal media device of claim 1, wherein said audio phone comprises a bone conduction transducer configured to transmit at least a portion of audio content through at least a portion of the body of the user.

8. The personal media device of claim 1, wherein said eyewear interface device comprises a bone conduction transducer configured to couple to the eyewear assembly.

9. The personal media device of claim 1, wherein said eyewear interface device comprises a bone conduction transducer configured to couple to the temple arm of the eyewear assembly.

10. The personal media device of claim 1, wherein said eyewear interface device comprises straps that extend behind a neck of the user, said straps comprising a pocket configured to receive a media device.

11. The personal media device of claim 1, wherein said branch is configured to support said audio phone proximate an audio receiving portion of a body of the user when the user is wearing the eyewear assembly and when the eyewear assembly is hanging about the user's neck supported by at least one of straps that extend behind a neck of the user and said branch.

12. A personal media device comprising:
a source of at least one of audio content and visual content;
a respective bone conduction transducer and visual display device communicatively coupled to said source of at least one of audio content and visual content, said visual display device coupled to an eyewear assembly of a user, the visual content visible at least one of directly on said visual display device and indirectly projected onto a lens of the eyewear assembly; and
an eyewear interface device comprising at least one receptacle configured to receive a temple arm of the eyewear assembly; a branch configured to support said visual display device in a substantially constant relative position with respect to the eyewear assembly, said branch further configured to support said bone conduction transducer proximate an audio receiving portion of a body of the user.

13. The personal media device of claim 12, wherein said audio receiving portion of a body of the user comprises a cranial bone of the user.

14. The personal media device of claim 12, wherein said audio receiving portion of a body of the user comprises a temporal bone of the user.

15. The personal media device of claim 12, wherein said bone conduction transducer is coupled to the temple arm.

16. The personal media device of claim 12, wherein said bone conduction transducer is affixed to an outer surface of said eyewear interface device

17. The personal media device of claim 12, wherein said bone conduction transducer communicates with said source of at least one of audio content and visual content wirelessly.

18. A method of sensing media content comprising:
coupling a source of at least one of audio content and visual content to an eyewear assembly;
supporting the source of at least one of audio content and visual content about the body of a user using the eyewear assembly; and
transmitting audio content to an inner ear of a user;

19. The method of claim 18, wherein the supporting the source of at least one of audio content and visual content about the body of a user using the eyewear assembly comprises supporting the source of at least one of audio content and visual content about the body of a user using a strap assembly coupled to the eyewear assembly.

20. The method of claim 18, wherein the transmitting audio content to an inner ear of a user comprises transmitting audio content to an inner ear of a user through at least one of an auditory canal of the user and a cranial bone of the user.
